(19) United States
(12) Patent Application Publication
(10) Pub. No.: US 2007/0125126 A1
(43) Pub. Date: Jun. 7, 2007

(54) Polarizing glass article and method of manufacturing same

(75) Inventors: Masahiro Ichimura, Niigata (JP); Shozo Morimoto, Niigata (JP); Yuichi Aoki, Niigata (JP)

Correspondence Address: OSHA LIANG L.L.P., 1221 MCKINNEY STREET, SUITE 2800, HOUSTON, TX, 77010, US

(73) Assignee: Arisawa Mfg. Co., Ltd., Niigata (JP)

(21) Appl. No.: 11/295,715

(22) Filed: Dec. 6, 2005

(51) Int. Cl. C03C 10/00; B44F 1/06

(52) U.S. Cl. 65/33.1; 428/38

(57) ABSTRACT

A method of manufacturing the polarizing glass article including elongated metal particles dispersed and oriented therein comprise; a preparing process in which a mother glass including metal ions is prepared; a reducing process in which the mother glass is heated at the lower temperature than the glass transition point temperature to be reduced at least a part of the metal ions for enough time to turn the metal ions into metal particles; a precipitating process in which the mother glass after the reducing process is heated at the higher temperature than the glass transition point temperature so that metal particles are precipitated; and an elongating process in which the mother glass after the precipitating process is heated and elongated.

### BACKGROUND OF THE INVENTION

1. Field of the Invention

The invention relates to polarizing glass articles which can be used for liquid crystal display (LCD) televisions, LCD projectors, or other imaging devices and a method of manufacturing the same.

2. Related Art

Polarizers are widely applied for imaging devices such as LCD televisions and LCD projectors, as well as for optical communication systems. There are some types of polarizers; absorption polarizers absorbing light with an organic material or an inorganic phase separated structure, birefringent crystal polarizers, and inorganic multi-layered polarizers, each of which has own features.

Especially, the organic or inorganic absorption polarizers are more usable because they can absorb either TE-wave (S-wave) or TM-wave (P-wave) to provide polarized light. The absorption polarizer can be shaped into a thin plate so that devices which incorporate it can be designed more freely. The absorption polarizer is typically used in imaging devices and optical communication systems, which require components including polarizers to be light, thin, and small.

Although the inorganic multi-layered polarizer also can be made light, thin, and small, similarly to the organic/inorganic polarizer, it reflects either TE-wave or TM-wave to provide polarized light. It's a problem, therefore, that it is difficult to treat such reflected light. The organic absorption polarizer absorbs unwanted light from a light source. The absorbed light causes thermal damage. This is the reason why the organic absorption polarizer is rather unsuitable for applications which require components to have a high durability. The applications of the inorganic absorption polarizer are expected to increase.

FIG. 1 shows states of a polarizing glass article, or an example of inorganic absorption polarizers in each stage of a prior art manufacturing method, referred to as the prior art method. The prior art method comprises at least a precipitating, or heat treating process, an elongating process, and a reducing process. Metal halides are first melted with glass to prepare a mother glass 11, and then in the precipitating process, the metal halide particles 13 are then precipitated within the mother glass 11 as shown in FIG. 1A. The mother glass 11 is formed into a glass preform, and then in the elongating process, the glass preform including the metal halide particles 13 is elongated to prepare a glass sheet 41. See FIG. 1B. The elongated glass sheet 41 is polished, and then in the reducing process the elongated metal halide particles 15 included in the glass sheet 41 are reduced in an atmosphere of hydrogen, for example, to turn into elongated metal particles 19. See FIG. 1C. The above prior art method is disclosed, for example, in the Japanese laid-open patent No. 2005-49529.

The conventional polarizing glass article disclosed in the Japanese laid-open patent No. 2005-49529, according to its manufacturing method, has relatively large elongated metal halide particles therein, so that it makes light scattered and absorbed, which causes a problem of decreasing visible light transmittance.

### SUMMARY OF THE INVENTION

To solve the above problems, according to the first embodiment of the present invention, a method of manufacturing a polarizing glass article including elongated metal particles dispersed and oriented therein comprises; a preparing process in which a mother glass including metal ions is prepared; a reducing process in which the mother glass is heated at lower temperature than the glass transition point temperature to be reduced in sufficient time for at least a part of the metal ions turning into metal particles; a precipitating process in which the mother glass undergone the reducing process is treated with heat at the higher temperature than the glass transition point temperature to precipitate metal particles; and a elongating process in which the mother glass undergone the precipitating process is heated and elongated.

In the above manufacturing method of the polarizing glass article, the preparing process may include a melting process, in which glass, metal ions, and halogen ions are melted.

In the above manufacturing method of the polarizing glass article, the preparing process may include an ion exchanging process, in which metal ions are put in glass by ion exchanging.

In the above manufacturing method of the polarizing glass article, the mother glass may be heated at higher temperature than the straining point temperature during the reducing process.

In the above manufacturing method of the polarizing glass article, the metal ions contained in the thickness of the mother glass of 50 μm to 200 μm including the surface thereof may be reduced.

In the above manufacturing method of the polarizing glass article, the mother glass may be heated to lower temperature than the softening point temperature during the precipitating process.

In the above precipitating process, the metal particles may be precipitated in the diameter of 20 nm to 150 nm.

According to the second embodiment of the present invention, polarizing glass articles including elongated metal particles dispersed and oriented therein, and having not less than 70% transmittance of incident light in the wavelength range of not less than 500 nm is provided.

It is preferred that the contrast ratio of transverse electric (TE) wave, or S-wave to transverse magnetic (TM) wave, or P-wave of the above polarizing glass article is 100:1 or more in the wavelength range of not less than 200 nm.

It is also preferred that the above polarizing glass article has the 80% or more transmittance of incident light in the wavelength range of not less than 520 nm.

The above summary of the present invention doesn't include all of the necessary features. The sub-combinations of these features may be inventions.

Apparently from the above description, according to the present invention, the mother glass is heated and reduced at the temperature equal to or lower than the glass transition point temperature in the reducing process so that nucleating or crystal nuclei growing of the metal halides in the mother glass can be controlled, while the metal ions included in the surface part of the mother glass can be reduced. Therefore, the transmittance of the polarizing glass article can be increased. The thickness of 50 μm to 200 μm including the surface of the mother glass can be controlled optimally, where the metal ions are reduced in the reducing process. In the precipitating process, the particle sizes of the precipitated metal particles can be optimally controlled between 20 nm and 150 nm. The polarizing glass article can be provided, in which the transmittance of the incident light in the visible wavelength range of not less than 520 nm is 80% or more, and the contrast ratio of TE-wave (S-wave) to TM-wave (P-wave) in the wavelength range not less than 200 nm is 100:1 or more.

### BRIEF DESCRIPTION OF THE DRAWINGS

FIG. 1 shows states of glass in each process in a prior art manufacturing method of a polarizing glass article.

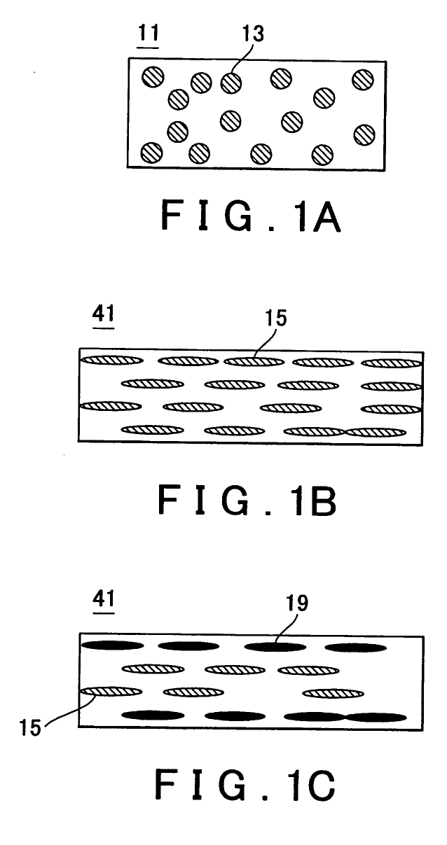

FIG. 2 is schematic illustrations of plain views and cross section views of a glass preform 20 and a glass sheet 40.

FIG. 3 shows the relationship between heat treating conditions and transmittances.

FIG. 4 shows a structure of an elongating apparatus 100 used in the elongating process of the present embodiment.

FIG. 5 shows a structure of a drawing means in the elongating apparatus 100.

FIG. 6 shows the relationship between temperatures of a mother glass and time for the heat treating process in the prior art method.

FIG. 7 shows the relationship between temperature of the mother glass and time for the heat treating process in the present manufacturing method.

FIG. 8 shows the TE-wave transmittances of the polarizing glass articles made in the first embodiment and the first comparative example.

FIG. 9 shows the transmittance of the polarizing glass article made in the first embodiment.

### DETAILED DESCRIPTION OF THE INVENTION

The following description explains the present invention with embodiments. The embodiments described below do not limit the invention claimed herein. All of the combinations described on the embodiments are not essential to the solutions of the present invention.

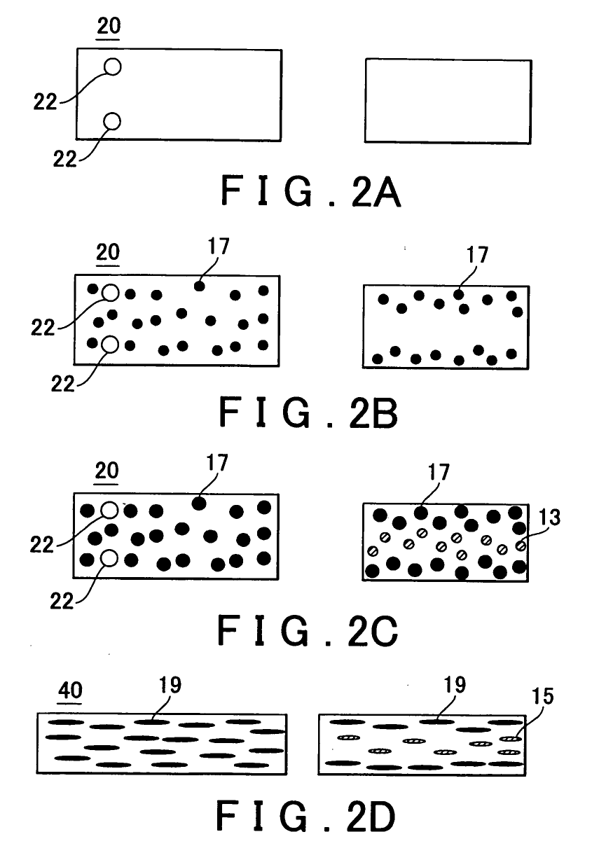

The method of manufacturing polarizing glass articles of the present embodiment, referred to as the present method, comprises; a preparing process, in which a mother glass including at least metal ions therein is prepared; a forming process, in which the mother glass is formed into a glass preform; a reducing process, in which the glass preform is reduced; a precipitating process, in which the glass preform is treated with heat to precipitate and grow metal particles; and an elongating process, in which the glass preform included the metal particles is elongated. FIGS. 2A-2D are schematic plain and cross section views of the glass preform and the glass sheet after the forming process, the reducing process, the precipitating process, and the elongating process respectively. The right side illustrations in FIGS. 2A-2D show the schematic cross section views, and the left side ones show the schematic plain views. Each schematic cross section view shows a part of the glass preform 20 or the glass sheet 40 which is supposed to continue over the right or left end in Figure.

In the preparing process, for example, a glass raw batch and metal halide raw materials are melted together and solidified to prepare the mother glass. Alumino borosilicate glass may be used as the glass raw batch, silver chloride (AgCl) and silver bromide (AgBr) may used as the metal halide raw materials.

Sodium ions included in the glass raw batch may be exchanged for monovalent metal ions or alkali metal ions such as silver ions by putting the said metal ions therein to make the mother glass. There is an ion exchanging method, in which the mother glass is soaked in a fused salt bath. The salt used for the fused salt bath may be an appropriate mixed salt including metal ion required to be put in, such as silver ion. The mixed salt may be a mixture of silver nitrate and alkali metal nitrate. There is another ion exchanging method, in which silver is evaporated on the surface of the mother glass to form a silver depositing layer, which is applied a voltage to exchange ions.

In the forming process, the mother glass is cut out a plate or a block to form into a glass preform as shown in FIG. 2A. Holes for mounting a supporting means for the glass preform, shown in FIGS. 2A-2C, are used to fix the glass preform to a glass supporting means 115 of an elongating apparatus 100.

In the reducing process, at least a part of metal ions included in the glass preform 20 is reduced. See FIG. 2B. For example, the glass preform 20 is put in a reducing furnace filled by an atmosphere of hydrogen, and heated so that the metal ions contained in the desired thickness including the surface of the glass preform 20 are reduced. The thickness can be controlled by the reducing temperature, or temperature of the atmosphere in the furnace, or the reducing time.

It is preferred that the reducing temperature in the present method is not less than the straining point temperature of the glass preform 20 and not more than the glass transition point temperature thereof. The reducing temperature is relatively low, which is not more than the glass transition point temperature, so that non-precipitated metal ions and halogen ions can be prevented from turning into metal halide particles 13 to be precipitated in the glass preform. The metal halide particles 13 undergone the precipitating and elongating processes which are post processes following to the reducing process turn into elongated metal halide particles 15 in the polarizing glass article. If such elongated metal halide particles exist a lot in the polarizing glass article, the transmittance of the polarizing glass article decreases. Therefore, if the precipitation of the metal halide particles 13 is controlled, the transmittance of the polarizing glass article can increase.

The reducing time of the present method may be, for example, as long as the time in which at least a part of the reduced metal ions in the glass preform 20 is precipitated as metal particles 17, and the metal ions contained in the thickness of not more than 200 μm including the surface of the glass preform 20 is reduced. The polarizing glass article after the post processes has a layer with enough thickness contained the elongated metal particles 19, and a great polarization performance.

In the precipitating process, for example, the glass preform 20 may be treated with heat in a heat resisting vessel to grow the metal particles 17 precipitated in the above reducing process, and contained in the surface of the glass preform 20, and to precipitate the metal halide particles 13. The heat treating temperature and time, depending on a shape of the glass preform, are the temperature which is not less than the glass transition point temperature and not more than the softening point temperature, and at least one hour. The metal particles 17 contained in the surface layer of the glass preform 20 grow in the diameter of between about 20 nm and 200 nm, preferably between 50 nm and 100 nm.

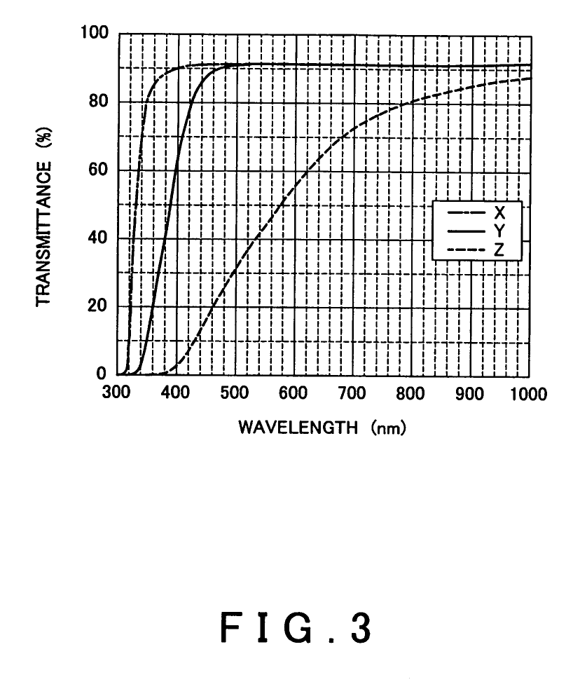

FIG. 3 shows the visible light transmittances of three types of the mother glasses having the same composition; the first mother glass shown by X in FIG. 3 isn't treated with heat; the second one shown by Y in FIG. 3 is treated with heat at 620° C. for 4 hours according to the present method; and the third one shown by Z in FIG. 3 is undergone the prior art precipitating process at 620° C. for one hour, and continued to be treated at 730° C. for another four hours. As shown in FIG. 3, compared to the glass with no heat treating, the glass undergone the precipitating process of the prior art method has much smaller transmittances in the visible light region. The glass undergone the precipitating process of the present method, however, has slightly smaller transmittances.

As shown by the curved line “Y” showing the precipitating process of the present method, compared to the curved line “X” in FIG. 3, the minimum wavelength of the absorbed light is longer, indicating that the silver halide particles 13 are precipitated in the glass preform 20. In the present precipitating process, following to the present reducing process (at 495° C. for 24 hours, and in the atmosphere of hydrogen), it is expected that the metal particles 17 grow in the surface layer of the glass preform 20, and the metal halide particles 13 are precipitated inside the glass preform 20. The above reducing process is done at not more than the glass transition point temperature so that few metal halide particles 13 are generated inside the glass preform 20, or grow their crystal nuclei. Even if the glass preform 20 is heated at higher temperature than the glass transition point temperature to be precipitated the metal halide particles 13 therein, the metal halide particles 13 are thought to be as big as their crystal nuclei, which is smaller than the metal particles 17. Therefore, the transmittance of the polarizing glass article can not decrease so much.

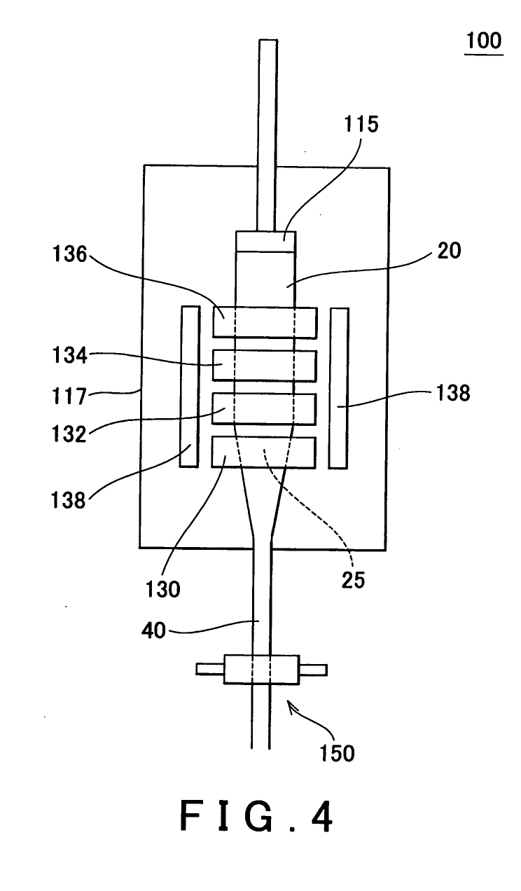

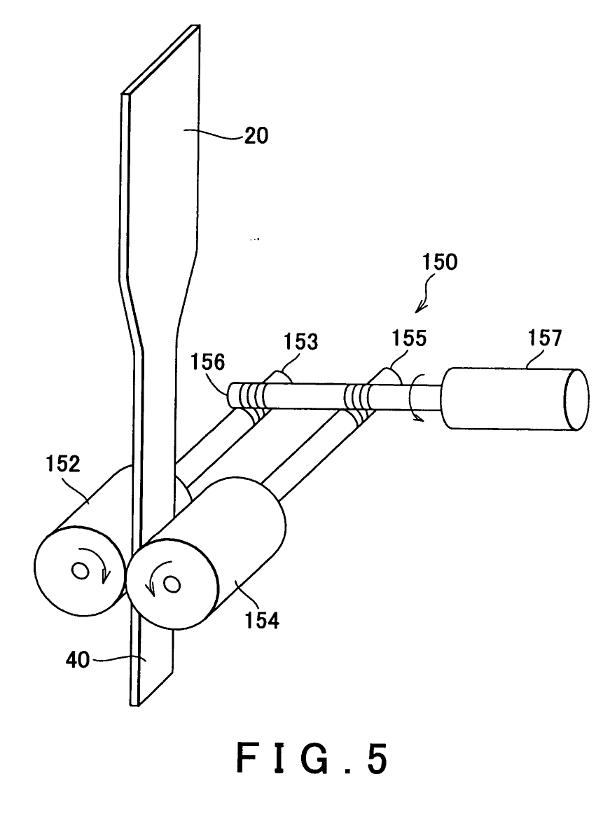

In the elongating process, the glass preform 20 is heated at a given temperature and elongated to make a glass sheet 40 having elongated metal particles 19. FIG. 4 shows the structure of an elongating apparatus 100 used in the elongating process of the present embodiment. FIG. 5 shows the structure of a drawing means 150 of the elongating apparatus 100.

As shown in FIG. 4, the elongating apparatus 100 comprises an electrical furnace 117, a glass supporting means 115 incorporated in the electrical furnace 117, a main heater 130, sub-heaters 132, 134, and 136, and side heaters 138, all of which are also incorporated in the electrical furnace 117, and a drawing means 150 set below the various heaters along the longitudinal direction of the glass preform 20.

The elongating apparatus 100 heats the glass preform 20 with the various heaters set around the glass preform 20 to elongate the same. Therefore, the metal particles 17 and the metal halide particles 13, both of which are included in the glass preform 20 are elongated to make the glass sheet 40 including the elongated metal particles 19 and the elongated metal halide particles 15. See FIG. 2D. Especially, the glass preform 20 shaped in a strip is fixed to the glass supporting means 115 via the mounting holes 22; heated by the main heater 130, the sub heaters 132, 134, and 136, and the side heaters 138; and elongated along the longitudinal direction thereof by the drawing means 150 set below the heaters.

The glass preform 20 is heated by; the main heater 130 which heats near the center of the width of the elongated part 25 from the front of the strip of elongated part where the glass preform shrinks across the width; the side heaters 138 which heat the sides of the elongated part 25 from the sides of the strip of the elongated part 25; and the sub-heaters 132, 134, and 136 set above the main heater 130 at certain intervals. Each power of the main heater 130, sub-heaters 132, 134, and 136, and side heaters 138 is controlled independently. This allows the glass preform 20 to be heated with the appropriate temperature distribution to be elongated, for example, with the temperature distribution where the viscosity of the glass preform 20 is between 1×10⁷ poise and 1×10⁹ poise. Therefore, the metal particles 17 in the glass preform 20 can be elongated in the required oval shape so that the glass preform 20 doesn't have to be polished in the post processes, which allows making the polarizing glass article having a high transmittance in the visible light region.

As shown in FIG. 5, the drawing means 150 comprises; a pair of nip rollers 152 and 154 sandwiching the both sides of the glass sheet 40; a pair of driven shafts 153 and 155 integrally rotating with the pair of nip rollers 152 and 154 respectively; a driving shaft 156 mechanically synchronizing to drive the driven shafts 153 and 155; and a motor 157 providing rotary drive power for the driving shaft 156. Each of the driven shafts 153 and 155 has a spiral gear with the same pitch. The gears engaging the spiral gears of driven shafts 153 and 155 are formed in the driven shaft 156.

The glass preform 20 is shaped in the present elongating process not to generate warps while being elongated and to make the geometric moment of inertia in the specific shape of elongated part of the glass preform 20 at least 13 mm⁴ so that the glass sheet 40 undergone the elongating process can be prevented from warping. In the prior art method of polarizing glass article described above, the glass sheet 41 after the elongating process is polished to have an uniform thickness, while in the present embodiment, the glass sheet 40 after the elongating process can have the thickness accuracy of plus or minus 10 μm without such polishing, which allows cutting the polishing cost.

The following explains the experiments assuring the effects of the prior art method and the present method.

### EMBODIMENT 1

The glass batch which includes, in weight percent, Li₂O: 1.8 wt %, Na₂O: 5.5 wt %, K₂O: 5.7 wt %, B₂O₃: 18.2 wt %, Al₂O₃: 6.2 wt %, SiO₂: 56.3 wt %, Ag: 0.24 wt %, Cl: 0.16 wt %, Br: 0.16 wt %, CuO: 0.01 wt %, Zr O₂: 5.0 wt %, TiO₂: 2.3 wt %, was pre-melted in a platinum melting pot at the temperature of about 1350° C. The pre-melted glass was broken into cullets which are as big as candies, then full-melted in the platinum melting pot at the temperature of about 1450 degrees, poured into a graphite mold to be cast, and annealed in an annealing furnace. Brought out from the annealing furnace, the mother glass was prepared. The table 1 shows the thermophysical properties of the mother glass. The temperature error is about plus or minus 10° C.

TABLE 1

| | | | | | | linear |
|---|---|---|---|---|---|---|
| | Glass | | | | | coefficient |
| | transition | Yield | Straining | Annealing | Softening | of |
| Refractive | point | point | point | point | point | expansion |
| index nd | temp. Tg | temp. | temp. | temp. | temp. | α (×10⁻⁷/ |
| λ = 587.56 nm | (° C.) | At (° C.) | (° C.) | (° C.) | (° C.) | ° C.) |
| 1.527 | 511-519 | 592-607 | About 450 | About 530 | About 700 | 69-71 |

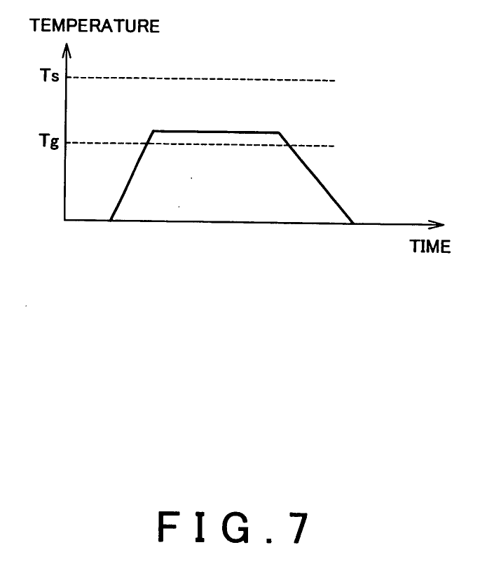

The above mother glass was cut out and shaped in the size of 70 mm in width, 250 mm in length, and 3 mm in thickness, having the geometric moment of inertia of 22 mm⁴ to form a glass preform, and reduced at 495° C. for 24 hours in the atmosphere of hydrogen. The glass preform was heated at 620° C., for 4 hours to be precipitated metal particles therein. FIG. 7 shows the relationship between temperature of the mother glass and time when it was treated with heat. The glass preform undergone the heat treating was heated at the temperature thereof at which the viscosity thereof was about 1×10¹⁰ poise to 1×10¹¹ poise, applied the stress of between 700 kg/cm² and 800 kg/cm², and elongated to make a glass sheet. The glass sheet was given a finish processing to make a polarizing glass article.

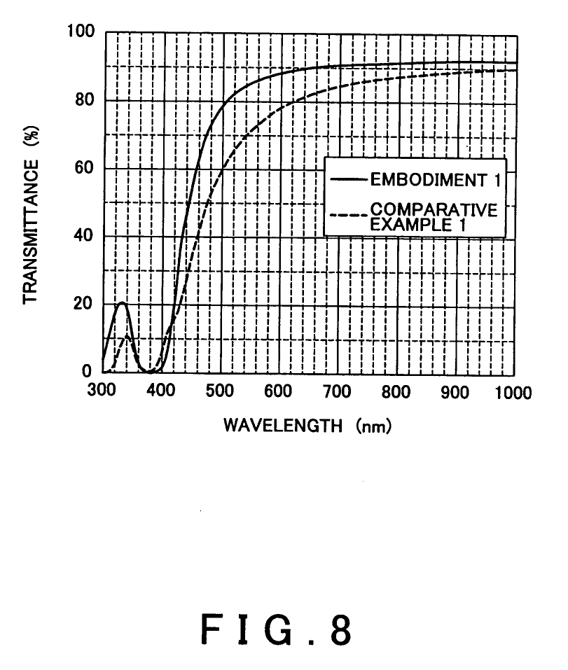

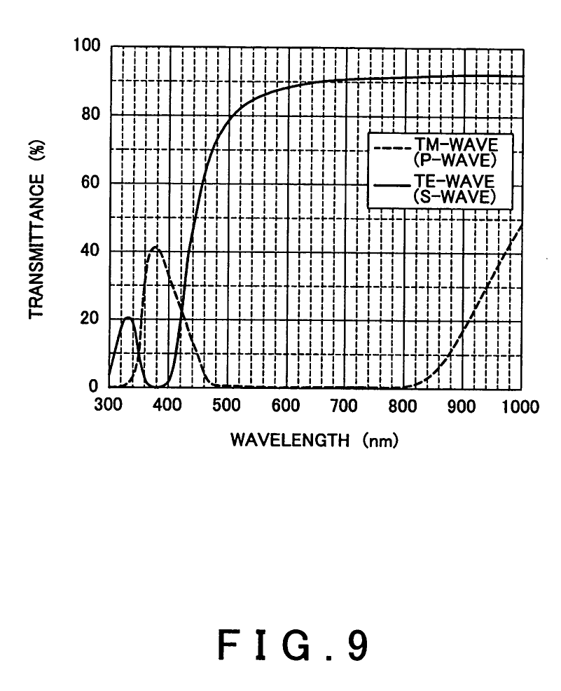

FIG. 8 shows the TE-wave transmittances of the resulted polarizing glass articles made in the embodiment 1 and the comparative example 1 below. As shown in FIG. 8, the polarizing glass article made in the embodiment 1 had 80% or more transmittance of TE-wave in the visible wavelength region of not less than 520 nm, or the green to red region. As shown in FIG. 9, the contrast ratio of the TE-wave (S-wave) to the TM-wave (P-wave) of the polarizing glass article made in the embodiment 1 was 100:1 or more in the wavelength range of not less than 560 nm. The thickness accuracy of the polarizing glass article made in the embodiment 1 was plus or minus 10 μm.

### COMPARATIVE EXAMPLE 1

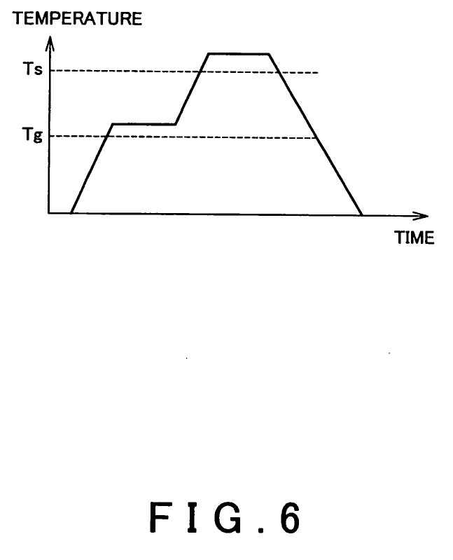

The above mother glass was heated at 610° C., for one hour, and continued to be heated at 740° C., for another 4 hours to be precipitated metal halide particles. FIG. 6 shows the relationship between the temperature of the mother glass and time for the heat treating. The particle sizes of the metal halide particles precipitated in the mother glass undergone the heat treating were about 70 to 150 nm. The mother glass was cut out and shaped in a plate of 70 mm in width, 250 mm in length, and 2 mm in thickness and having geometric moment of inertia of 7 mm⁴ to form a glass preform. The glass preform was elongated at the temperature at which the viscosity thereof was between about 1×10⁷ poise and 1×10⁹ poise with the stress of about 400 kg/cm² to make a glass sheet. The glass sheet was reduced at 470° C., for 4 hours, in the atmosphere of hydrogen, and at the atmospheric pressure, and done a finishing processing to make a polarizing glass article.

As shown in FIG. 8, the polarizing glass article made in the comparative example 1 has the 65% transmittance of TE-wave in the visible wavelength of 520 nm. The contrast ratio of TE-wave (S-wave) to TM-wave (P-wave) of the polarizing glass article made in the comparative example 1 was about 90:1 in the range over 560 nm. The thickness accuracy of the polarizing glass article made in the comparative example 1 was plus or minus 80 μm.

According to the present embodiment, the mother glass is heated at the temperature of not more than the glass transition point temperature, and reduced so that the metal halide can be prevented from nucleating and growing the crystal nuclei thereof inside the mother glass to reduce the metal ions included in the surface layer of the mother glass. This allows the transmission of the polarizing glass article to increase very much. The polarizing glass article can be provided, in which the transmittance of the incident light in the wavelength range of not less than 520 nm is 80% or more, and the contrast ratio of TE-wave (S-wave) to TM-wave (P-wave) is 100:1 or more in the wavelength range of not less than 200 nm. The glass sheet undergone the elongating process was smooth enough without polishing, which allows cutting the polishing cost differently from the prior art method.

The above description explaining the present invention with the embodiments does not limit the technical scope of the invention to the above description of the embodiments. It is apparent for those in the art that various modifications or improvements can be made to the embodiments described above. It is also apparent from what we claim that other embodiments with such modifications or improvements are included in the technical scope of the present invention.

What is claimed is:

1. A method of manufacturing a polarizing glass article including elongated metal particles dispersed and oriented therein which comprises;
a preparing process in which a mother glass including metal ions is prepared;
a reducing process in which the mother glass is heated at lower temperature than the glass transition point temperature to be reduced in sufficient time for at least a part of the metal ions turning into metal particles;
a precipitating process in which the mother glass undergone the reducing process is treated with heat at the higher temperature than the glass transition point temperature to precipitate metal particles; and
a elongating process in which the mother glass undergone the precipitating process is heated and elongated.

2. The method of manufacturing a polarizing glass article according to claim 1, wherein said preparing process includes a melting process in which said glass, said metal ions, and halogen ions are melted.

3. The method of manufacturing a polarizing glass article according to claim 1, wherein said preparing process includes an ion exchanging process in which said metal ions are put in said glass by ion exchanging.

4. The method of manufacturing a polarizing glass article according to claim 1, wherein said mother glass is heated at higher temperature than the straining point temperature in said reducing process.

5. The method of manufacturing a polarizing glass article according to claim 4, wherein metal ions contained in the thickness of 50 μm to 200 μm of said mother glass including the surface thereof are reduced in said reducing process.

6. The method of manufacturing a polarizing glass article according to claim 1, wherein said mother glass is heated at the lower temperature than the softening point temperature in said precipitating process.

7. The method of manufacturing a polarizing glass article according to claim 6, wherein said metal particles are precipitated in the diameter of between 20 nm and 150 nm in said precipitating process.

8. A polarizing glass article including elongated metal particles dispersed and oriented therein, and having not less than 70% transmittance of incident light in the wavelength range of not less than 500 nm.

9. The polarizing glass article according to claim 8, wherein the contrast ratio of the same is 100:1 or more in the wavelength range of not less than 200 nm.

10. The polarizing glass article according to claim 8, wherein the transmittance of the incident light in the wavelength range of not less than 520 is 80% or more.
